(19) United States
(12) Patent Application Publication
(10) Pub. No.: US 2007/0044468 A1
(43) Pub. Date: Mar. 1, 2007

(54) Energy recovery system for combustible vapors

(75) Inventor: Benjamin Ziph, Ypsilanti, MI (US)

Correspondence Address: BRINKS HOFER GILSON & LIONE, P.O. BOX 10395, CHICAGO, IL, 60610, US

(73) Assignee: STM POWER, INC.

(21) Appl. No.: 11/217,899

(22) Filed: Sep. 1, 2005

(51) Int. Cl. F02G 1/04; F01B 29/10

(52) U.S. Cl. 60/520

(57) ABSTRACT

An energy recovery system permits recovering energy from fumes. The system employs a heat engine such as a Stirling engine, and a supplemental combustible fuel. A combustor receives the paint fumes as well as the supplemental fuel from a fuel supply. The fuel supply includes a fuel throttle regulating the fuel mass flow rate. An air blower provides air to the combustor. The heat engine includes a heater receiving heat from the combustor. A temperature sensor detects the temperature of the heater, while a controller operatively controls the fuel throttle to vary the fuel mass flow rate based on the temperature of the heater.

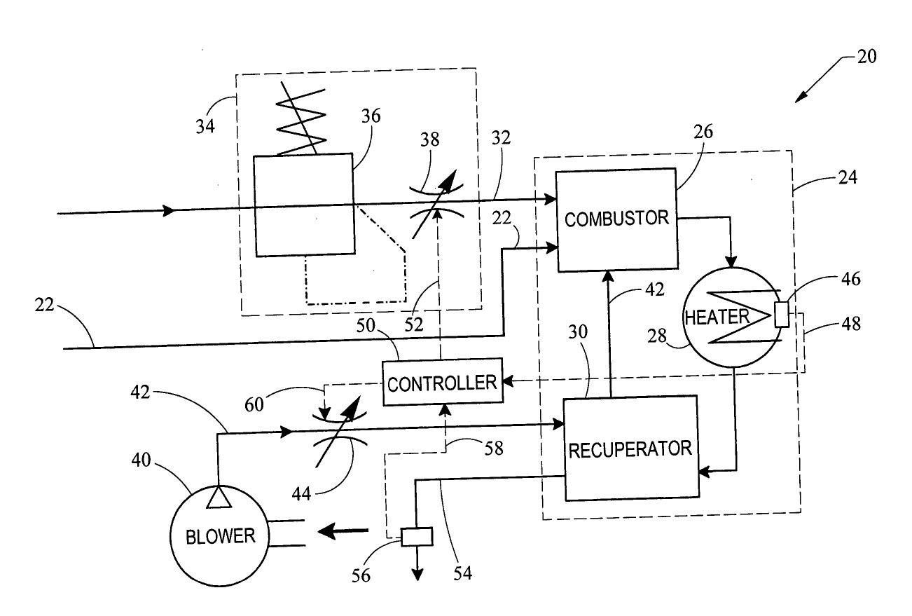

### FIELD OF THE INVENTION

The present invention relates generally to energy recovery systems, and more particularly relates to the use of heat engines such as Stirling engines for energy recovery.

### BACKGROUND OF THE INVENTION

Paint is generally a solid pigment dissolved in a volatile liquid solvent. When the paint is sprayed on a surface, the volatile solvent evaporates while the solid pigment settles on the surface. These volatile solvent vapors, commonly referred to as paint fumes, are hazardous and may not be discharged to the atmosphere. Accordingly, the paint fumes are generally scrubbed and incinerated. While it may appear that, with newly developed means to concentrate the solvent vapors in the scrubbing gas, such waste products could be combusted to provide energy, the concentration of solvents in the paint fumes can range from a few parts per million (ppm) to thousands of ppm, resulting in a heat value that greatly varies. Therefore, it is difficult to recover energy from these paint fumes due to the varying levels of combustible solvents.

Accordingly, there exists a need to provide an energy recovery system that is capable of recovering energy from concentrated paint fumes despite variations in solvent concentration.

### BRIEF SUMMARY OF THE INVENTION

The present invention provides an energy recovery system capable of recovering energy from paint fumes and other combustible volatile agents. The system employs a heat engine such as a Stirling engine, and a supplemental combustible fuel used in conjunction with the paint fumes. Generally, a combustor receives the paint fumes as well as the supplemental fuel from a fuel supply. The fuel supply includes a fuel throttle regulating the fuel mass flow rate. An air blower provides air to the combustor. The heat engine includes a heater receiving heat from the combustor. A temperature sensor detects the temperature of the heater, while a controller operatively controls the fuel throttle to vary the fuel mass flow rate based on the temperature of the heater.

Accordingly to more detailed aspects, the controller varies the fuel mass flow rate to maintain a generally constant temperature of the heater. The paint fumes would typically be provided at a constant mass flow rate, although the concentration of solvent vapor in the paint fumes varies from a minimum level to a maximum level. The system is thus designed such that the maximum level of solvent vapor does not over heat the heat engine. For example, the heat engine may be sized to utilize the maximum level of solvent vapor, or the mass flow rate of the paint fumes may be fixed at a level to prevent over heating. Similarly, the system is designed such that the highest equivalence ratio (air fuel ratio to stoichiometric ratio, described later herein) does not exceed the lean blow-out limit, and such that the lowest equivalence ratio does not exceed the rich over-heat limit.

Additionally, the energy recovery system may include an air throttle regulating the air mass flow rate. The controller may operatively control the air throttle to regulate the air mass flow rate based on the position of the fuel throttle. Additionally, the energy recovery system preferably includes an oxygen sensor detecting the level of oxygen in the exhaust. Thus, the controller may also operatively control the air throttle based on the level of oxygen in the exhaust. In this manner, the equivalence ratio can be kept at a generally constant level, thereby preventing the combustor from reaching the lean blow-out limit or the rich over-heat limit.

### BRIEF DESCRIPTION OF THE DRAWINGS

The accompanying drawings incorporated in and forming a part of the specification illustrate several aspects of the present invention, and together with the description serve to explain the principles of the invention. In the drawings:

The FIGURE is a schematic depiction of an energy recovery system constructed in accordance with the teachings of the present invention.

### DETAILED DESCRIPTION OF THE INVENTION

An energy recovery system 20 has been schematically depicted in accordance with the teachings of the present invention. The energy recovery system 20 generally is employed for recovering energy from paint fumes 22 which are collected from an area in which painting occurs. It will be recognized that the energy recovering system 20 may be employed with numerous other combustible agents, solvents or fumes, and the system 20 will be described in connection with paint fumes 22 as one example. Recently, a process has been developed whereby the paint fumes are scrubbed with nitrogen and the mixture of solvent vapors and nitrogen is fed to a concentrator (not shown), in which the concentration of the solvent vapors is increased until the mixture (referred to herein as paint fumes 22) has a sufficiently high heat value to serve as fuel. The concentrator supplies a constant mass flow rate of paint fumes 22, but as noted above, the concentration of solvents in the fumes 22 varies widely between a minimum level to a maximum level. Typically, the composition of the solvents in the paint fumes 22 does not change appreciably, although the system can be adjusted to accommodate some variation in solvent composition. As such, the solvent heat value and the stoichiometric air-fuel ratio are roughly constant.

The fumes 22 are provided to a heat engine 24 for recovery of energy. The heat engine 24 used in conjunction with the energy recovery system 20 can comprise a Stirling cycle heat engine similar to those previously developed by the Assignee of the present invention, STM Power, Inc., including those described in U.S. Pat. Nos. 4,996,841; 5,074,114; 5,611,201; 5,706,659; 5,722,239; 5,771,694; 5,813,229; 5,836,846; 5,864,770; the disclosures of which are hereby incorporated by reference in their entirety.

Generally, the heat engine 24 includes a combustor 26, a heater 28 and a recuperator 30, as is well know in the art. These devices are disclosed in detail in the aforementioned patents, and a preferred combustor has been developed by the Assignee STM Power, Inc., as disclosed in U.S. Pat. No. 5,921,764, the disclosure of which is incorporated herein by reference in its entirety. These elements, including the combustor 26, may be separately formed from the engine 24, or may be integrated therein such as is disclosed in U.S. Pat. Nos. 5,074,114 and 5,388,409, the disclosures of which are hereby incorporated by reference in their entirety. Similarly, a preferred construction of the heater 28 is shown in U.S. Pat. No. 6,282,895, the disclosure of which is hereby incorporated by reference in its entirety.

In order to overcome the limitations imposed by the varying concentration of solvent vapor in the paint fumes 22, the heat engine 24 and its combustor 26 are also supplied with supplemental fuel 32. The fuel 32 is a combustible fuel, preferably a gas such as natural gas, propane, or some other high-quality fuel. A fuel supply 34 includes a pressure regulator 36 and a fuel throttle 38 for regulating the mass flow rate of the fuel 32 delivered to the combustor 26. The combustor 26 burns the paint fumes 22 which are mixed with the supplemental fuel 32. A blower 40 provides air 42 to the combustor 26 for mixing with the fumes 22 and fuel 32. Generally, a constant mass flow rate of combustion air 42 may be supplied by the blower 40 to the combustor 26, although the air mass flow rate can also be controlled as will be discussed in more detail below. The products of combustion from the combustor 26 flow through the heater 28 and recuperator 30, which extract heat energy therefrom. The products of combustion are then passed out of the heat engine 24 as exhaust 54.

In order to accommodate the variances in the concentration of solvent vapor in the paint fumes 22, and hence variations in the heat value of the fumes 22, a sensor 46 is provided in communication with the heater 28 to sense the temperature thereof. The sensor 46 may be attached to tubes contained within the heater 28 having the working fluid that is heated by the combustor 26. A temperature signal 48 is sent to a controller 50, which in turn is operatively connected to the fuel throttle 38. The temperature sensor 46 is preferably a proportional, integral, derivative (PID) type sensor suitable for close loop control as is well known in the art. In the preferred construction, the controller 50 operates the fuel throttle 52 in order to maintain a generally constant temperature in the heater 28. The term generally constant, as used herein, means a variation of less than plus or minus 5%, or ±50 degrees Celsius. Accordingly, based on the temperature of the heater 28, an appropriate amount of supplemental fuel 32 may be provided to the heat engine 24 in order to extract energy from paint fumes 22.

It will be recognized, that even when no supplemental fuel 32 is provided, the maximum concentration of the solvent vapor in the fumes 22 must not result in over heating of the engine 24. Accordingly, the maximum level of solvent concentration is identified beforehand and the system is designed to prevent overheating. For example, the size of the heat engine 24 may be selected based on this maximum level. Further, multiple heat engines 24 may be employed, and the stream of paint fumes 22 can be split to supply each heat engine of the system 20. Likewise, the mass flow rate of the paint fumes 22 emanating from the concentrator may be selected based on the capacity of the heat engine 24.

As is known in the art, the ratio of combustion air 42 to the mixed fuel 22, 32 often differs from the stoichiometric ratio, and the ratio of the air-to-fuel ratio to the stoichiometric ratio is referred to as the equivalence ratio. As such, when the equivalence ratio is above one, the engine is running “lean”, and when it is less than one the engine is running “rich”. When the fuel throttle 38 is run to maintain a constant temperature of the heater 28, and when the air mass flow rate is constant, the equivalence ratio (λ) may be expressed as:

$$λ = \frac{{\dot{m}}_{a} {h}_{g}}{{ρ}_{g} \dot{Q} - {\dot{m}}_{f} ( {ρ}_{g} {h}_{s} - {ρ}_{s} {h}_{g} ) C} \qquad ( 1 )$$

where m is mass flow rate, C is mass fraction of solvents in the fumes 22, ρ is stoichiometric mass air/fuel ratio, h is heat value, \dot{Q} is total fuel heat input to the combustor 26, and λ is the equivalence ratio. Subscript s refers to solvents, f refers to fumes 22, g refers to gas 32, and refers to air 42.

As such, the behavior of the air to fuel ratio (and hence λ) depends on the sign of the expression (ρ_{g}h_{s-ρ}ₛh_{g}). If this expression is positive, then increasing solvent concentration will lean out the combustion. If this expression is negative, then increasing solvent concentration will enrich the combustion. Therefore, the highest and lowest equivalence ratios are calculated for each of the two above-noted situations, (i.e. where increasing solvent concentration either leans out the combustion or enriches the combustion).

Accordingly, the highest equivalence ratio λ should not exceed the lean blow-out limit (i.e. the amount of combustible fuel is insufficient to support combustion), and the lowest equivalence ratio should not exceed the rich overheat limit (i.e. the amount of combustible fuel is too high to support combustion). Thus, the system 20 may be designed to accommodate these limitations. For example, the controller 50 may operate the fuel throttle 38 to regulate the air to fuel ratio to avoid exceed either of these limits. Likewise, the heat engine 24 may be cycled on and off. Most preferably, these two requirements may be met by modulating the mass flow rate of the air 42.

As shown in the FIGURE, the controller 50 uses a control signal 60 to operate the air throttle 44 and regulate the air to fuel ratio. The air throttle 44 may be controlled based on the predetermined behavior of the equivalence ratio A as effected by the operation/position of the fuel throttle 38. However, the energy system 20 preferably includes an oxygen sensor 56 for use in controlling the air throttle 44. The oxygen sensor 56 is positioned downstream of the heat engine 24 and the recuperator 30 to sense the level of oxygen in the exhaust 54. The oxygen sensor 56 is preferably a PID-type sensor. A signal 58 indicative of the level of oxygen in the exhaust 54 is sent to the controller 50, which in turn may use this data to operate the air throttle 44. In particular, the air throttle 44 may be operated to maintain a constant oxygen level in the exhaust 54. Similarly, the controller 50 may operate the air throttle 44 in order to maintain a constant equivalent ratio λ, or at least to ensure that the equivalence ratio λ does not exceed either the lean blow-out limit or the rich over heat limit as previously discussed.

Accordingly, it will be recognized by those skilled in the art that the energy recovery system 20 of the present invention allows for recovery of energy from paint fumes 22 having varying levels of solvent concentration, and thus varying levels of heat energy. A heat engine such as a Stirling cycle heat engine, provides a reliable and efficient method for extracting heat from the paint fumes by combining the fumes with a supplemental fuel. This, in combination with a feedback control loop tied to the heater of the heat engine, allows a constant tube temperature to be maintained within the heater to ensure reliable recovery of energy from the paint fumes. The system may readily be tailored to prevent overheating of the engine, and with the addition of an air throttle, and preferably an oxygen sensor in the exhaust pathway, increased control over the operating parameters of the energy recovery system 20 may be readily achieved.

The foregoing description of various embodiments of the invention have been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An energy recovery system for recovering energy from fumes having a sufficiently high heat value to serve as a combustible fuel, the system comprising:
a combustor receiving the fumes;
a fuel supply providing a supplemental combustible fuel to the combustor, the fuel supply including a fuel throttle regulating the fuel mass flow rate;
an air blower providing air to the combustor;
a heat engine having a heater receiving heat from the combustor;
a temperature sensor detecting the temperature of the heater; and
a controller operatively controlling the fuel throttle to vary the fuel mass flow rate based on the temperature of the heater.

2. The system of claim 1, wherein the controller varies the fuel mass flow rate to maintain a generally constant temperature of the heater.

3. The system of claim 1, wherein the temperature sensor is a PID-type sensor.

4. The system of claim 1, wherein the fumes are provided at a constant mass flow rate.

5. The system of claim 1, wherein the fumes include solvent vapor, and wherein the concentration of solvent vapor in the fumes varies from a minimum level to a maximum level.

6. The system of claim 5, wherein the system is designed such that the maximum level of solvent vapor does overheat the heat engine.

7. The system of claim 5, wherein the heat engine is sized to utilize the maximum level of solvent vapor without overheating.

8. The system of claim 6, wherein the mass flow rate of the fumes is fixed at a level to prevent overheating.

9. The system of claim 1, wherein the system is designed such that the highest equivalence ratio does not exceeded the lean blow-out limit.

10. The system of claim 1, wherein the system is designed such that the lowest equivalence ratio does not exceed the rich over-heat limit.

11. The system of claim 1, further comprising an air throttle regulating the air mass flow rate.

12. The system of claim 11, wherein the controller operatively controls the air throttle to regulate the air mass flow rate based on the position of the fuel throttle.

13. The system of claim 11, further comprising an oxygen sensor detecting the level of oxygen in the exhaust from the combustor and heater, and wherein the controller regulates the air mass flow rate based on the level of oxygen in the exhaust.

14. An energy recovery system for recovering energy from fumes, the system comprising:
a combustor receiving the fumes;
a fuel supply providing a supplemental combustible fuel to the combustor, the fuel supply including a fuel throttle regulating the fuel mass flow rate;
an air blower providing air to the combustor;
an air throttle regulating the air mass flow rate from the air blower;
a Stirling engine having a heater receiving heat from the combustor;
a temperature sensor detecting the temperature of the heater;
an oxygen sensor detecting the revel of oxygen in the exhaust from the combustor and heater; and
a controller operatively controlling the fuel throttle to vary the fuel mass flow rate based on the temperature of the heater, the controller operatively controlling the air throttle to vary the air mass flow rate based on one or both of position of the fuel throttle or the level of oxygen in the exhaust.

15. The system of claim 14, wherein the controller varies the fuel mass flow rate to maintain a generally constant temperature of the heater.

16. The system of claim 14, wherein the controller varies the air mass flow rate to maintain a generally constant equivalence ratio.

17. The system of claim 14, wherein the fumes include solvent vapor, and the concentration of solvent vapor in the fumes varies from a minimum level to a maximum level, and wherein the system is designed such that the maximum level of solvent vapor does overheat the Stirling engine.

18. The system of claim 14, wherein the controller operates the air throttle such that the highest equivalence ratio does not exceed the lean blow-out limit.

19. The system of claim 14, wherein the controller operates the air throttle such that the lowest equivalence ratio does not exceed the rich over-heat limit.

20. The system of claim 1, wherein the fumes and supplemental fuel are mixed upon entering the combustor.

21. The system of claim 14, wherein the fumes and supplemental fuel are mixed upon entering the combustor.
